(19) United States
(12) Patent Application Publication
(10) Pub. No.: US 2003/0158743 A1
(43) Pub. Date: Aug. 21, 2003

(54) Method and apparatus for organizing, accessing and displaying data relating to trademark rights

(76) Inventors: Scott spenser Havlick, Boulder, CO (US); Donald Alois Degnan, Boulder, CO (US)

Correspondence Address: Ronald C. Gorsche, Jr., HOLLAND & HART LLP, P.O. Box 8749, Denver, CO, 80201, US

(21) Appl. No.: 10/079,627

(22) Filed: Feb. 19, 2002

(51) Int. Cl. G06F 17/60

(52) U.S. Cl. 705/1; 283/115

(57) ABSTRACT

An interactive user interface for organizing, storing, accessing and presenting information associated with a trademark search, trademark watch report or the scope of trademark rights of a trademark owner. Trademark information is visually depicted in an interactive user interface in a manner that is easy to follow and understand. In addition, trademark watch report information and new documents, data, or information may be added to the interface without disturbing the integrity of the user interface.

### BACKGROUND OF THE INVENTION

1. Field of the Invention

The present invention relates, in general, to trademarks. More particularly, the present invention is directed to a method and apparatus for presenting and accessing information associated with assessing the availability, registrability and potential scope of rights in a trademark.

2. Relevant Background

A trademark portfolio is a valuable asset. In most cases, however, the portfolio's significance cannot be assigned a dollar value that is directly attributable to a company's profitability. Instead, trademarks create brand recognition amongst consumers and potential consumers. As a product or service acquires good will in the mind of consumers and potential consumers, the trademark becomes the vehicle for accumulating and generating future revenues from that good will. In essence, a trademark makes it easier for consumers to quickly confirm the source and verify the quality of a good or service sold under the trademark.

A trademark owner's ability to distinguish its goods or services from those of its competitors varies according to the strength of the trademark that is used to sell the trademark owner's goods or services. If the trademark owner adopts a distinctive mark, and effectively uses and enforces its trademark rights, the trademark owner should be able to prevent others from selling directly competing, related or sometimes even unrelated goods or services under a confusingly similar mark. Likewise, if the trademark owner adopts a distinctive mark, and effectively uses and enforces its trademark rights, it can expect to prevent others from adopting no only identical marks, but connotatively, phonetically or visually similar marks. Consequently, assessing the potential strength of a new trademark, before it is adopted, is an important step in the trademark selection process.

Typically, a trademark owner will consult with a trademark professional and often a trademark searching company to fully search a proposed new trademark to determine whether and how the proposed new trademark is being used by others. The information contained in a search report is used by the trademark professional to assess whether the proposed mark can be successfully registered, whether the proposed use of the new mark will infringe the rights of any third party, and to assess the potential scope of rights, or trademark equity potential, the new proposed mark might enjoy. Sometimes, in order to reach these conclusions, the trademark professional will require follow up investigations of references in the search report. It is important to assess the scope of rights for any particular trademark before a mark is adopted, because the trademark owner's actions subsequent to the adoption of the mark can dramatically broaden or narrow the scope of rights for any given trademark. Trademarks with earlier priority dates can be acquired by the trademark owner, effectively broadening the scope of protection that can be expected for the newly adopted mark. On the other hand, a trademark owner's acquiescence to third party uses of similar marks on similar goods/services can subsequently narrow the scope of the trademark owner's rights in a mark.

Once a trademark is searched and cleared as being available, a trademark owner is obliged to vigilantly monitor third party use of the trademark. Often opposition proceedings, cancellation actions and civil litigation are required of the trademark owner to maintain the full scope of rights in a trademark. A trademark watch service is often employed by the trademark owner or trademark professional to assist in this policing function. A watch service will provide the trademark owner or professional with notification of any similar or related mark on any similar or related goods or services. Watch services can be engaged to monitor federal, state, and foreign trademark offices and provide notification of new applications and/or new registrations, as well as newly published marks. Watch services are also available to watch a wide variety of databases looking for infringing uses of a mark in telephone directories, secretary of state corporate filings, on the Internet, in online directories and databases, and a wide variety of other sources.

There are numerous companies that offer a wide variety of intellectual property research products and services for the intellectual property professional. Specifically, companies such as Thomson & Thomson, Trademark Research Corporation, and CCH Corsearch offer valuable products and services in the trademark area, including trademark searches, follow up clearance investigations, and a wide variety of watch services. These companies are well equipped with extensive knowledge and experience to provide a fully comprehensive and thoroughly exhaustive trademark search using the many sources of information available. Since the trademark search entity is more skilled at knowing where to search and how to search, the use of outside trademark search companies greatly reduces the amount of time the intellectual property professional must devote to searching so as to free up time to spend on counseling activity.

Each new third party use presents a unique enforcement dilemma to the trademark owner. Does that use infringe the trademark owner's scope of rights? What precedent will the trademark owner create by declining to pursue the newly-identified third party? Has the trademark owner declined to pursue other similarly situated third parties in the past?

The volume of information that trademark searches and watch services generate can be substantial. The gathering, storage and dissemination of information associated with a trademark can be an onerous task for even a single mark. Many trademark owners have portfolios of dozens and even hundreds of marks. These marks are often handled by numerous trademark professionals in different geographic locations. In many instances, the right hand may not know what information the left hand holds. It is easy for information to get lost, misplaced or overlooked. In some extreme cases, tasks may be duplicated or missed, all at a considerable cost to the trademark owner.

In every instance, there is a need to cull through and identify the most important information in the search report and in subsequent investigations and watch notices. Much of the information in the searches and many of the watch reports are less relevant to the trademark owner. Many high level executives are time pressed and cannot devote large blocks of time to understanding the vast amount of information associated with their company's trademark portfolio. Similarly, business meetings discussing a single mark or group of marks are also time critical. The time available to present understandable information is at a premium. The important parts of the search can be difficult to locate, decipher and understand without an exhaustive review of all the information contained in the search. It is therefore desirable to centrally organize, access and graphically present information associated with a trademark in a quick, simple and efficient manner.

### SUMMARY OF THE INVENTION

The foregoing and other features, utilities and advantages of the invention will be apparent from the following more particular description of a preferred embodiment of the invention as illustrated in the accompanying drawings.

Briefly stated, the present invention involves a mechanism, method, and computer program product for presenting information associated with a trademark. A graph is generated having a first axis and a second axis with the origin of the graph at the intersection of the first and second axis. The goods/services description associated with the specific goods or services to be offered or being offered under the trademark being placed at a point on the first axis of the graph closest the origin. Other goods/services descriptions are placed at different points on the first axis of the graph with the more dissimilar goods/services being placed further from the origin and the more similar goods and services being placed closer to the origin. The mark description associated with the trademark is then placed at a point on the second axis of the graph, with the identical mark being placed closest the origin. Other mark descriptions are placed at different points on the second axis of the graph with increasingly dissimilar variations of the mark being placed further from the origin along the second axis. The graph is then populated with data points representing several trademarks from a trademark search report or trademark watch notices.

In accordance with one aspect of the present invention, a method for presenting information associated with a trademark search for a trademark is disclosed. A mark description and a goods/services description associated with the trademark are identified. A graph is generated having a first axis and a second axis. The first axis has one or more descriptions of goods/services. The second axis has one or more mark descriptions. The origin cell on the first and second axes of the graph comprises the goods/services description and the mark description associated with the trademark. The graph is populated with at least one data point by plotting each data point on the graph using the goods/services description and the mark description associated with a mark from the trademark search.

In accordance with another aspect of the present invention, the classes defined in the International Schedule of Classes of Goods and Services, as defined by the international treaty and the U.S. trademark rules and regulations, are be placed on the first axis with the most relevant classes being placed closest to the origin. Other classes are placed at different points on the first axis of the graph with the classes containing the less similar goods or services being placed further from the origin or in another logical numeric order along the first axis.

In accordance with yet another aspect of the present invention, a computer implemented graphical user interface (GUI) for capturing and displaying information associated with a trademark is disclosed. The GUI comprises a graph having a first axis and a second axis. The first axis has one or more descriptions of goods/services and the second axis has one or more mark variations and/or descriptions. The origin point, or the intersection of the first axis and the second axis, comprises the goods/services description and the mark description associated with the trademark. The GUI has a user selectable data point comprising a mark plotted on the graph using the associated goods/services description and mark description. The user selectable data point is configured to invoke a retrieve and display tool to retrieve information associated with the user selectable data point and thereafter display the information on a computer display.

### BRIEF DESCRIPTION OF THE DRAWINGS

FIG. 1 is a first system diagram of a computer network environment for implementing the present invention;

FIG. 2 is a second system diagram of a computer network environment for implementing the present invention;

FIG. 3 illustrates a graph having a first axis having a plurality of goods/services descriptions and a second axis having a plurality of mark descriptions;

FIG. 4 illustrates a graph populated with several user selectable data points showing shading in accordance with the properties of the underlying trademark;

FIG. 4a illustrates the concept of using the classes defined in the International Schedule of Classes of Goods and Services, as defined by the international treaty and the U.S. trademark rules and regulations, for the first axis;

FIG. 5 is a graph having a user selectable data point showing the blowout box for placing the mouse cursor over the data point;

FIG. 6 shows two graphs, the mark descriptions and the goods/services descriptions from second graph are chosen from the first graph;

FIG. 7 illustrates a graph with a third axis illustrating how the GUI can be used to assess a trademark owner's scope of rights or position in multiple foreign countries;

FIGS. 8-9 are flow charts illustrating the method of the present invention.

### DESCRIPTION OF THE SPECIFIC EMBODIMENTS

The trademark professional is constantly seeking techniques to streamline the process for receiving and presenting information associated with a trademark search, follow up investigations and clearance activities, as well as information received from watch notices after a mark is adopted. Similarly, the trademark search entity must constantly innovate to remain economically viable and not stagnate in such a highly competitive market. Innovation generates increased revenue and market share by offering unique products and services in tune with the trademark professional's particular needs.

As stated previously, the trademark search and the follow up clearance work that is conducted based upon information contained in the search report is probably the most important step in deciding whether to adopt a trademark. Typically, the first step in the trademark search is a direct hit or “knock out” search. The knock out search is a preliminary search that typically involves searching prior U.S. federal, state or international trademark registrations and applications to eliminate proposed trademarks that are obviously already taken and therefore unavailable. The knock out search is inexpensive and normally done prior to a more comprehensive trademark search. Typically, this type of search researches trademark directories or online trademark research systems.

Once the knock out search is complete, the next step in the search process is the comprehensive trademark search. The comprehensive trademark search is typically conducted by a trademark search entity that specializes in trademark research and has accumulated substantial databases for that purpose. The trademark professional analyzes the resulting research report to assess the potential conflicts that may accompany use of the proposed mark.

Trademark search entities such as Thomson & Thomson, Trademark Research Corporation, and CCH Corsearch provide outstanding search services. A comprehensive search is conducted by professional searchers who develop search strategies aimed at identifying not only identical marks, but also all marks that might be seen as confusingly similar in light of the goods or services being sold under those marks. Similar marks may include phonetic equivalents, synonyms, homonyms, antonyms, marks incorporating the same or similar prefix, suffix or root word and foreign translations if applicable. In addition, searchers include not only marks used on goods/services that directly compete with those of the new trademark's owner, but also goods/services that be seen as coming from the same source or as being sponsored by the trademark owner or visa versa. Significant discretion is involved in narrowing down the many “hits” identified by the searcher to a reasonable number for inclusion into the search report. Within the search report, a searcher may further attempt to organize the references to be included in the search report so that the most relevant references are placed nearer to the front of the search report.

The information contained in a search report is typically used by the trademark professional to assess whether the proposed mark can be successfully registered, whether the proposed use of the new mark will infringe the rights of any third party, and to assess the potential scope of rights, or trademark equity potential, the new proposed mark might enjoy. Sometimes, in order to reach these conclusions, the trademark professional will require follow up investigations of references in the search report. It is important to assess the scope of rights for any particular trademark before a mark is adopted, because the trademark owner's actions subsequent to the adoption of the mark can dramatically broaden or narrow the scope of rights for any given trademark. Trademarks with earlier priority dates can be acquired by the trademark owner, effectively broadening the scope of protection that can be expected for the newly adopted mark. On the other hand, a trademark owner's acquiescence to third party uses of similar marks on similar goods/services can subsequently narrow the scope of the trademark owner's rights in a mark.

Although a trademark search has significant potential blind spots and is the result of substantial discretion by the searching professional, comprehensive trademark searches are commonly relied upon by trademark professionals and trademark owners in deciding whether to adopt a new mark and in deciding the scope of enforceable trademark rights to which the trademark owner is entitled.

Once a trademark is searched and cleared as being available, a trademark owner is obliged to vigilantly monitor third party use of the trademark. Often opposition proceedings, cancellation actions and civil litigation are required of the trademark owner to maintain the full scope of rights in a trademark. A trademark watch service is often employed by the trademark owner or trademark professional to assist in this policing function. A watch service will provide the trademark owner or professional with notification of any similar or related mark on any similar or related goods or services. Watch services can be engaged to monitor federal, state, and foreign trademark offices and provide notification of new applications and/or new registrations, as well as newly published marks. Watch services are also available to watch a wide variety of databases looking for infringing uses of a mark in telephone directories, secretary of state corporate filings, on the Internet, in online directories and databases, and a wide variety of other sources.

The method and apparatus of the present invention is predicated on performing a trademark search, a trademark watch, or other means of learning of third party use of relevant trademarks in conjunction with a company's trademark. In addition, although aspects of the invention are described using the term “trademark”, a person skilled in the art can appreciate that the more general expression “trademark” may also apply to trade names, service marks, trade dress, collective membership marks, collective trademark/service marks and certification marks without departing form the intended scope of the invention. In addition, although aspects of the invention are described using the term “trademark search”, a person skilled in the art can appreciate that “trademark search” can apply to any activity investigating into information associated with a trademark and is not intended to be limited to a trademark search performed by a trademark search entity.

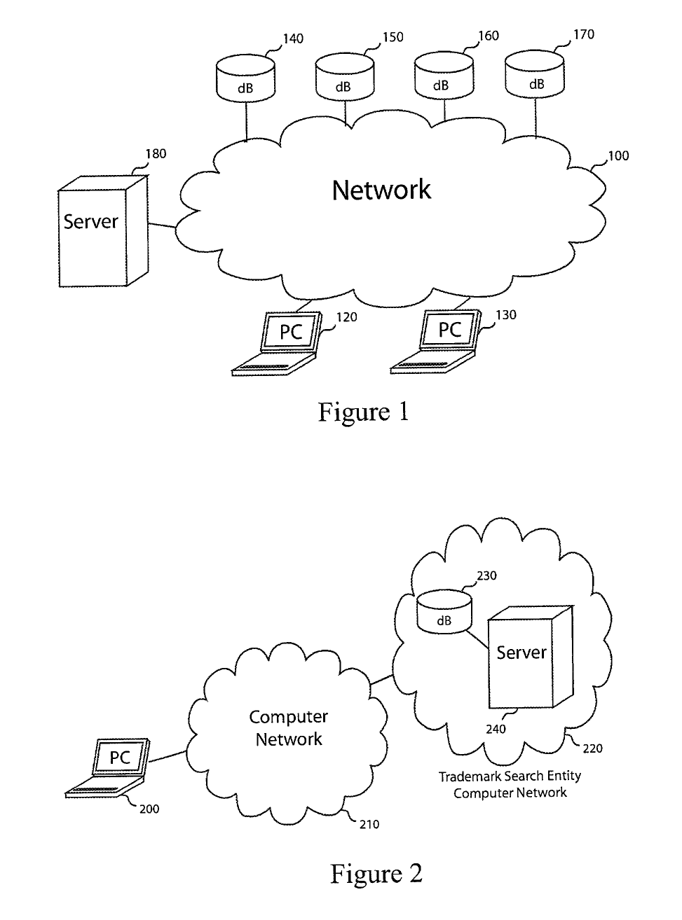

FIG. 1 shows a basic structure of a computer network suitable for use with the method and apparatus of the present invention. In FIG. 1, computer network 10 is coupled to a plurality of databases 40, 50, 60 and 70. Computer network 10 is also coupled to computers 20 and 30 such that both have access to databases 40, 50, 60 and 70. Network 10 may be implemented as a local intranet, the Internet or any other similar computer and storage based networking environment. The devices may be interconnected in different ways from that shown in FIG. 1. The operation of a computer network such as that shown in FIG. 1 is readily known in the art and is not discussed in detail in this application.

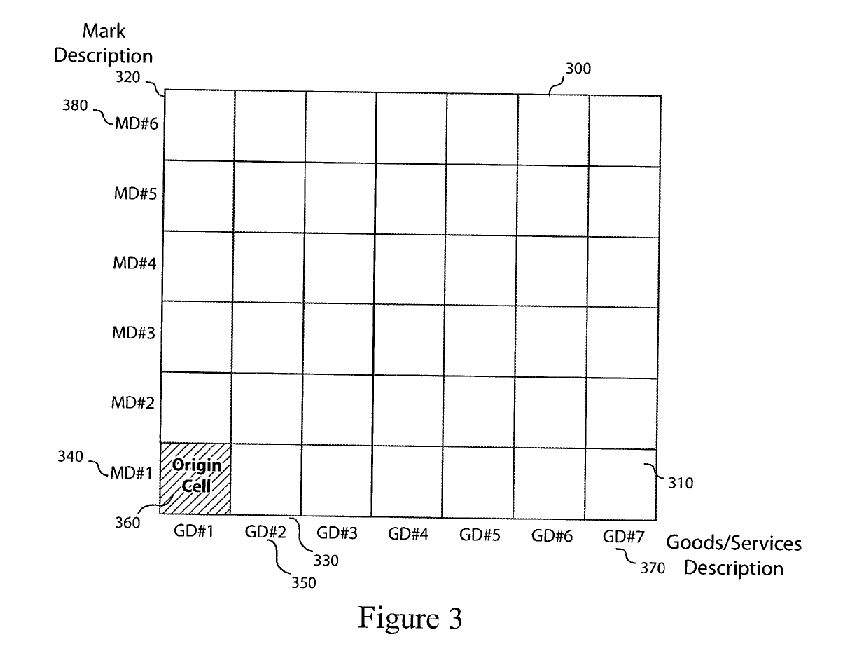

FIG. 2 illustrates a computer network more particularly directed to the interaction between the trademark professional and the trademark search entity. Personal computer 200 is coupled to a computer network 210. Computer network 210 can be the Internet, a local intranet, a fibre channel network or any similar computer network that allows communication between a user and a remote storage location. Trademark search entity computer network 220 is coupled to computer network 210 thereby giving multiple users the ability to connect from remote locations. Trademark search entity computer network 220 comprises a server 240 and a database 230. Server 240 provides a location for hosting the processing power to implement the computer software in accordance with the present invention. Database 230 provides a memory location to store any information accessible by computer network 210. Personal computer 200 is intended for use by the trademark professional to communicate with trademark search entity 220 over computer network 210.

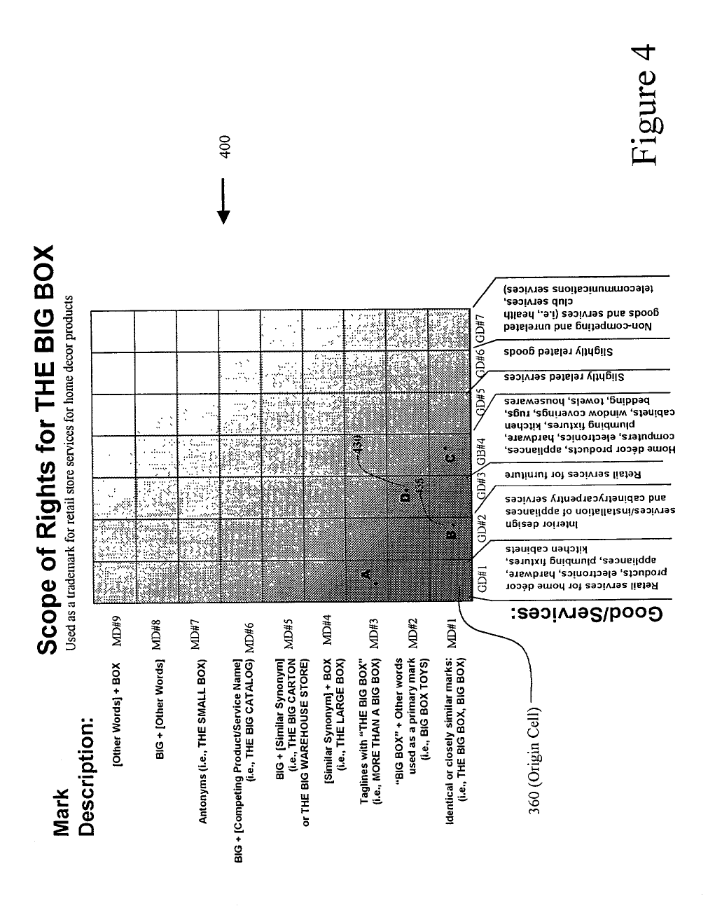

FIG. 3 illustrates an unpopulated graphical user interface (GUI) or graph 300 in accordance with one embodiment of the present invention. Graph 300 is formed by a first axis 330 and a second axis 320. The intersection of the first and second axis forms the origin 360 of the graph 300.

The goods/services description and the mark description associated with the trademark subject to the trademark search may form the goods/services description and the mark description associated with the origin 360. Origin 360 serves as the reference point for populating the remaining mark descriptions and goods/services descriptions along first axis 330 and second axis 320. In accordance with another aspect of the invention, GD#1 350 may recite the goods/services description associated with the subject trademark. Similarly, MD#1 340 may recite the mark description associated with the subject trademark. In this respect, a cell is defined by the intersection of a goods/services description and a mark description such as GD#1 350 and MD#1 340. It should be understood that each cell might be populated with multiple data points, as described hereinafter.

The first axis 330 is populated with a plurality of goods/services descriptions, labeled on graph 300 as GD#1 350 to GD#7 370 respectively. In another embodiment, GD#1 350 to GD#7 370 may comprise the classes defined in the International Schedule of Classes of Goods and Services, as defined by the international treaty and the U.S. trademark rules and regulations. The goods/services descriptions may be chosen before or after performing the trademark search. On the front end of the trademark search, the trademark professional may designate certain goods/services descriptions in accordance with goods and services currently offered by the owner of the trademark. If known, the trademark professional may also designate certain goods/services descriptions in accordance with prospective products intended to be offered by the owner of the trademark. On the back end, the trademark search entity may determine the goods/services descriptions associated with first axis 330 according to the results of the search report or some other criteria internal to the search entity. The plurality of goods/services descriptions may be automatically generated according to the goods/services description associated with the subject trademark or they may be manually generated by the search entity based on criteria provided by the trademark professional.

The plurality of goods/services descriptions are prioritized on the first axis 330 according to their respective similarity with the goods/services description associated with origin 360. In graph 300, GD#1 350 may have the identical goods/services description of the origin, whereas GD#7 may have little in common. For example, if the goods/services description associated with origin cell 360 is “electrically powered construction tools,” GD#1 may be designated “construction tools” whereas GD#7 may be designated “computer furniture.” As one skilled in the art can fully appreciate, the goods/services descriptions associated with first axis 330 will be more closely related for crowded art fields having overlapping goods/services descriptions.

The second axis 320 is populated with a plurality of mark descriptions, labeled on graph 300 as MD#1 340 to MD#7 380. Similar to the goods/services descriptions, the mark descriptions may be chosen before or after performing the trademark search. On the front end of the trademark search, the trademark professional may designate certain mark descriptions in accordance with variation s of the words and letters associated with the trademark. On the back end, the trademark search entity may determine the mark descriptions associated with second axis 320 according to the results of the search report or some other criteria internal to the search entity. The plurality of mark descriptions may be automatically generated according to the mark description associated with the subject trademark or they may be manually generated by the search entity based on criteria provided by the trademark professional.

The plurality of mark descriptions are prioritized on the second axis 320 according to their respective similarity with the mark description associated with origin 360. In graph 300, MD#1 340 has the identical goods/services description of the origin, whereas MD#7 380 may have only a single word in common. For example, if the mark description associated with origin cell 360 is “THE MEAN BEAVER” for a chainsaw, MD#1 may be designated “MEAN BEAVER” or “THE MEAN BEAVER” whereas MD#7 may be designated “BEAVER+other words” such as “BEAVER TEETH.” As one skilled in the art can fully appreciate, the mark descriptions associated with second axis 320 will be more closely related for crowded art fields having many similar mark descriptions.

The boundary of a grid in graph 300 is delineated by the goods/services description and the mark description on the respective intersecting first and second axis. For example, grid 310 is formed by the intersection of MD#1 340 and GD#7 370 respectively. The right and left edges of grid 310 comprise the boundary of the right and left edge of GD#7 370. The top and bottom edges of grid 310 comprise the top and the bottom edge of MD#1 340. Therefore, a mark plotted within grid 310 would have a description of goods/services in accordance with GD#7 370 and a mark description in accordance with MD#1 340.

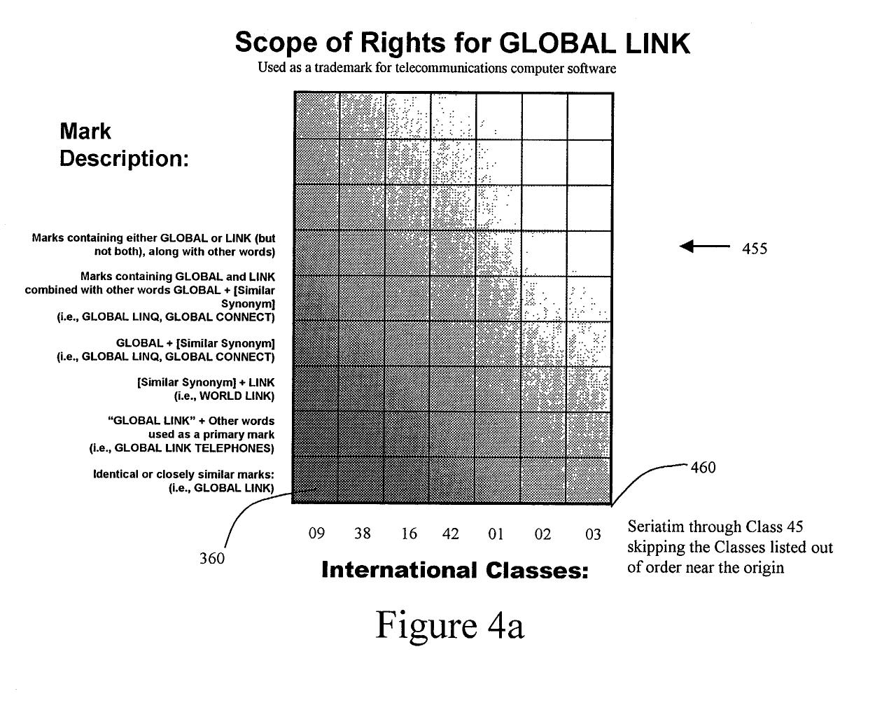

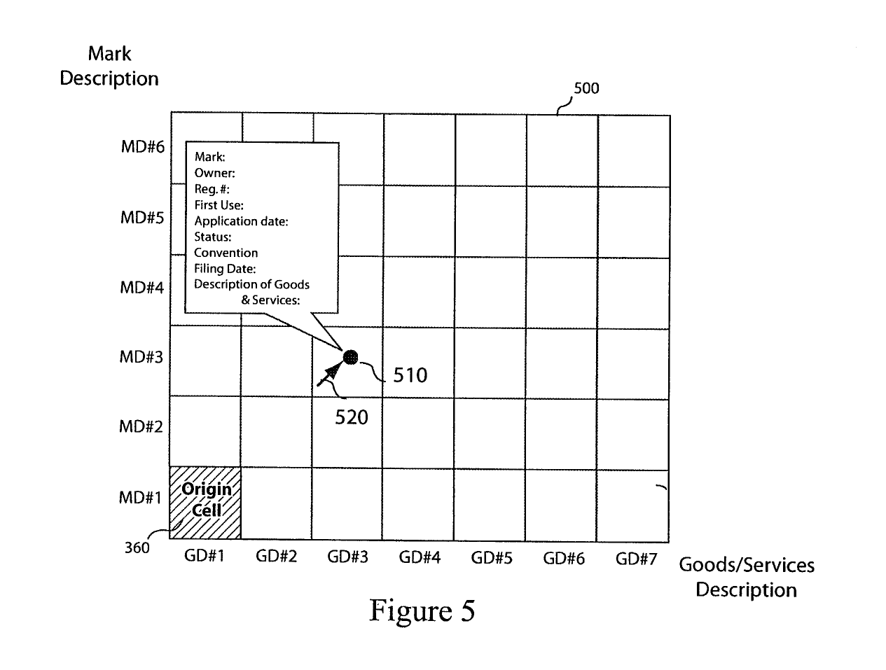

FIG. 4 illustrates a populated GUI 400 in accordance with one embodiment of the present invention. Once the graph illustrated in FIG. 3 is created, user selectable data points may be added thereby creating the interactive interface 400 shown in FIG. 4. For example, user selectable data point 430 is shown in GUI 400. Data point 430 is generated from a trademark from a search report having a goods/services description GD#2 and a mark description MD#2.

The various data points in GUI 400 may be shaded in accordance with their relationship to the searched trademark to further graphically clarify the nature of the data behind the data points. Legend 425 in FIG. 4 provides several examples of possible shadings. In the illustrated example, the trademark associated with interactive data point 435, having goods/services description GD#2 and mark description MD#1 would be a potential high priority enforcement candidate, due to its close proximate relationship to the goods/services and mark description of the searched trademark, which would be placed in the cell adjacent to the origin (referred to herein as the origin cell), 360.

The information associated with a user selectable data point 430 may be stored in a database. If selected, the GUI 400 invokes a retrieve and display tool to retrieve information associated with user selectable data point 430 and thereafter display the information on a computer display. This information could include, but is in no way limited to, the mark, the goods/services offered under the mark or for which the mark is registered, the priority date (first use date, application date or convention priority date), the registration number and status (if the mark is registered), and the owner name. The information could also include the full description of the mark as is typically set out in a comprehensive search report, imaged documents, investigation reports, html links and other data or links.

As briefly alluded to previously, GUI 400 also provides a visual representation of the current “lay of the land” for the trademark that is the subject of the search 360. This is an important tool for the trademark professional to quickly disseminate a large amount of information in a short period of time. GUI 400 shows the searched trademark 360 and its corresponding goods/services descriptions GD#1 and mark description MD#1 in a first shading. Less important marks that have an associated goods/services description and mark description that are less material to the trademark owner are shown in a different shading and are plotted furthest from the origin. Strong marks are shown in yet another shading and are plotted closer to the origin. Marks that should be investigated for enforcement are illustrated in still another shading. Based upon this contrast in shadings for differing conditions, anyone can analyze GUI 400 and quickly assess the strengths and the weaknesses of the trademark.

FIG. 4a illustrates a graph 455 in accordance with another aspect of the present invention. The graph 455 of FIG. 4a is formed by a first axis 460 and a second axis 470. The International classes and the mark description associated with the trademark subject to the trademark search may form the goods/services description and the mark description associated with the origin. Origin 360 serves as the reference point for populating the remaining mark descriptions and International class descriptions along first axis 460 and second axis 470. The intersection of the international class column and mark description row for the trademark forms the origin or origin cell 360 of the graph 455.

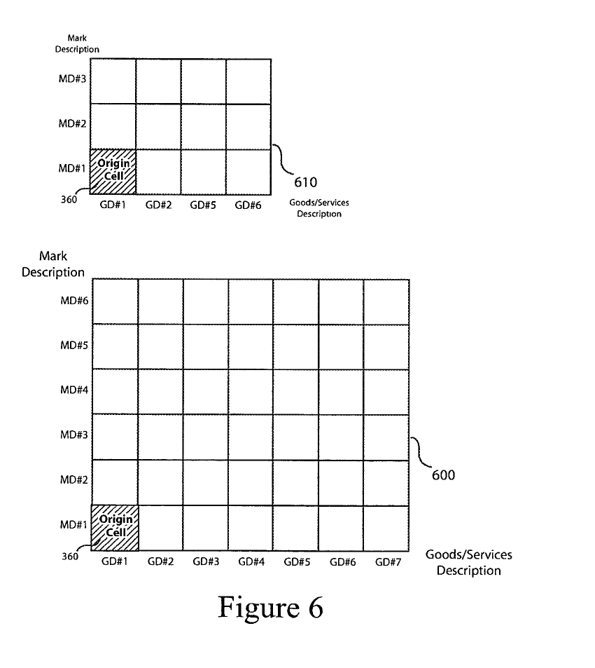

FIG. 5 shows a graphical user interface (GUI) 500 having an interactive data point 510. The user passes the mouse cursor 520 over an interactive data point 510. In response, pop-up window 530 is generated showing information associated with the trademark associated with interactive data point 510. Information in pop-up window 530 includes, but is in no way limited to, the mark description, the description of the goods/services, the International Class(es) involved the owner of the mark, when the mark was first used in commerce, any registration information and the database the mark was found from the search.

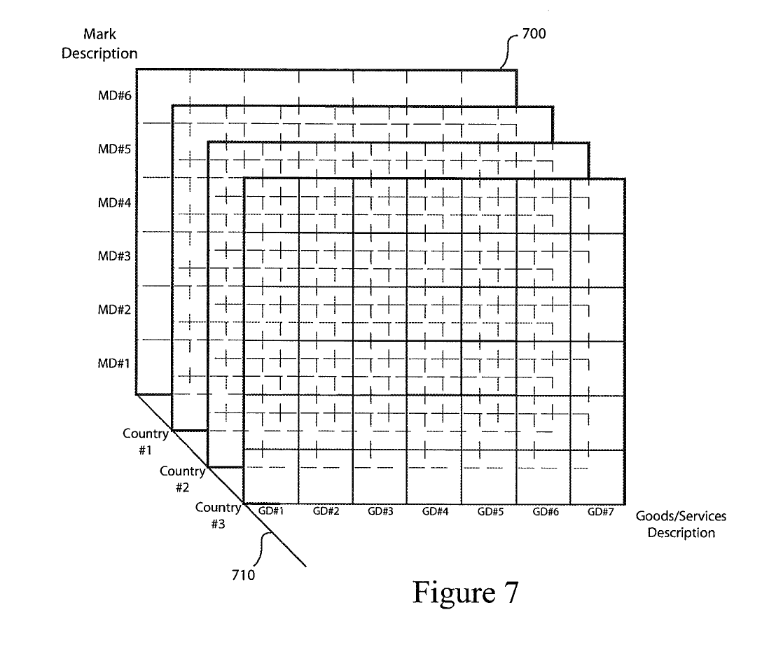

FIG. 6 illustrates a first graph 600 and a second graph 610 in accordance with another aspect of the present invention. The user selects less than all of the goods/services descriptions and mark descriptions from the first graph 600. A new graph 610 is generated having the user selected goods/services descriptions and mark descriptions populating the first and second axis of graph 610 respectively.

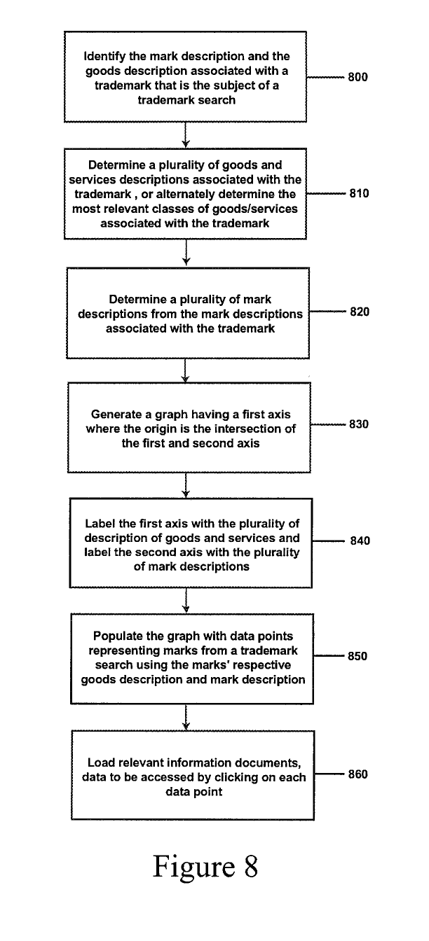

FIG. 7 shows a graph 700 having a third axis 710 in accordance with another aspect of the present invention. The third axis 710 is populated with a plurality of countries. In one embodiment, the third axis 710 is user selectable thereby overlaying the selected country onto graph 700 in response to a user selection. In another embodiment, graph 700 is a three dimensional depiction, thereby allowing concurrent viewing of all the countries along third axis 710.

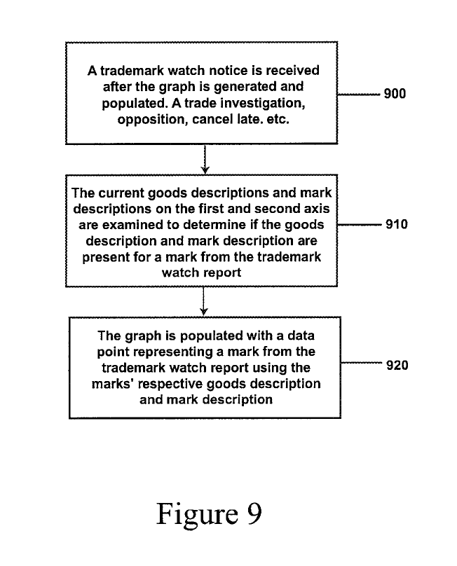

FIGS. 8 and 9 show flowcharts illustrating a method of the present invention.

The flowchart is illustrative of merely the broad logical flow of steps to achieve a method of the present invention and that steps may be added to, or taken away from, the flowchart without departing from the scope of the invention. Further, the order of execution of steps in the flowchart may be changed without departing from the scope of the invention. Additional considerations in implementing the method described by the flowchart may dictate changes in the selection and order of steps.

In general, the flowcharts in this specification include one or more steps performed by software routines executing in a computer system such as computer networks illustrated in FIGS. 1 and 2. The routines may be implemented by any means as is known in the art. For example, any number of computer programming languages, such as “C”, Pascal, FORTRAN, assembly language, etc., may be used. Further, various programming approaches such as procedural, object oriented or artificial intelligence techniques may be employed.

The steps of the flowcharts may be implemented by one or more software routines, processes, subroutines, modules, etc. Some considerations such as interrupt driven, polled, or other implementation schemes may affect the order of steps performed by software. A multiprocessing or multitasking environment could allow steps to be executed “concurrently.”

The flowchart of FIG. 8 is entered at step 800. At step 800, the mark description and goods/services description associated with a trademark is identified. The trademark is the subject of the trademark search performed by a trademark search entity. At step 810, the plurality of goods/services descriptions are determined suing the goods/services description associated with the subject trademark. The goods/services descriptions may be determined by the intellectual property professional or the trademark search entity. The goods/services descriptions may also be determined manually or automatically based on key words in the trademark's goods/services description.

Continuing with step 820, a plurality of mark descriptions are determined using the mark description associated with the trademark subject to the trademark search. Similar to the selection of goods/services descriptions described previously, the plurality of mark descriptions may be determined by the intellectual property professional or the trademark search entity. Typically, the mark descriptions are chosen based upon various combinations of the words and letters associated with the trademark. Mark descriptions may include phonetically similar variations as well.

At step 830, the graph or user interface of the present invention is generated. The graph has a first axis and a second axis and an origin formed by the intersection of the first and second axis. The goods/services description and mark description associated with the trademark are placed at the origin. At step 840, the plurality of goods/services descriptions are placed on the first axis and the plurality of mark descriptions are placed on the second axis. Typically, the goods/services descriptions are prioritized on the first axis and the mark descriptions are prioritized on the second axis according to their respective similarity to the goods/services description and mark description of the trademark.

As shown in step 850, once the graph is generated, the data points representing marks from a trademark search report may be added thereby creating the user interface. Each data point is plotted on the graph using a trademark from the trademark search report. If a trademark does not correspond with either the goods/services descriptions or mark descriptions on the first or second axes, a new goods/services description or mark description may be generated and added to the respective axis. The data points may be user selectable. In other words, the data points are associated with information in a database that is displayed upon selection by a user.

As shown in step 900, the flowchart of FIG. 9 illustrates receipt of a trademark watch report after a graph is generated and populated with several data points. A trademark professional typically requests a trademark watch report to monitor the ongoing changes in the universe for a particularly important mark. Once the trademark watch report is received, at step 910, the current goods/services descriptions on the first axis and mark descriptions on the second axis are examined to determine the presence or absence of the goods/services description and mark description for a mark associated with the trademark watch report. If either is lacking, the respective goods/services description or mark description is added to the first or second axis at an appropriate location according to its relation to the description at the origin. At step 920, the graph is then populated with a data point representing a mark from the trademark watch report using the mark's respective goods/services description and mark description.

In the foregoing specification, the invention has been described with reference to a specific exemplary embodiment thereof. It will, however, be evident that various modifications and changes may be made thereunto without departing from the broader spirit and scope of the invention as set forth in the appended claims. For example, various programming languages and techniques can be used to implement the disclosed invention. Also, the specific logic presented to accomplish tasks within the present invention may be modified without departing from the scope of the invention. Many such changes or modifications will be readily apparent to one of ordinary skill in the art. The specification and drawings are, accordingly, to be regarded in an illustrative rather than a restrictive sense, the invention being limited only by the provided claims.

We claim:

1. A method for presenting information associated with a trademark search for a trademark, the method comprising:
identifying a mark description and a goods/services description associated with the trademark;
generating a graph having a first axis and a second axis, wherein the origin of the graph comprises the intersection of the first and second axis, the first axis having one or more descriptions of goods/services and the second axis having one or more mark descriptions, wherein the origin comprises the goods/services description and the mark description associated with the trademark;
populating the graph with at least one data point, the act of populating comprising:
locating a mark description and a goods/services description associated with a mark from the trademark search on the first and second axis; and
plotting a data point on the graph using the goods/services description and the mark description associated with the mark from the trademark search.

2. The method of claim 1, further comprising:
determining the one or more mark descriptions associated with the second axis from variations of the trademark, wherein the variations utilize various combinations of the words and letters associated with the trademark; and
prioritizing the one or more mark descriptions on the second axis by decreasing similarity to the mark description associated with the trademark, wherein an identical mark description would be adjacent to the origin.

3. The method of claim 1, further comprising manually determining the one or more mark descriptions associated with the second axis.

4. The method of claim 1, further comprising:
determining the one or more description of goods/services associated with the first axis by identifying all goods and services currently being offered by the owner of the trademark and identifying all goods and services intended to be offered by the owner of the trademark; and
prioritizing the one or more description of goods on the first axis by decreasing similarity to the goods description associated with the trademark, wherein an identical goods description would be adjacent to the origin.

5. The method of claim 1, further comprising manually determining the description of goods associated with the first axis from the trademark search.

6. The method of claim 1 further comprising a plurality of grids within the graph, wherein the boundary of each grid is formed by a right and left edge from a description of goods/services from the first axis and a top and bottom edge from a mark description from the second axis.

7. The method of claim 6 further comprising:
a first shading of one of a plurality of grids for visually representing a mark other than the trademark; and
a second shading of one of a plurality of grids for visually representing areas of coverage for the trademark, whereby the availability of an expansion of trademark rights may be determined from analyzing the shading of the plurality of grids.

8. The method of claim 1, wherein the act of performing a trademark search comprises performing a direct hit trademark search for words or combination of words in the mark description of the trademark.

9. The method of claim 1, wherein the act of performing a trademark search comprises performing a comprehensive trademark search.

10. The method of claim 9, wherein the comprehensive trademark search comprises a search of the mark description of the trademark in a U.S. federal trademarks database, state trademarks database, common law use of trademarks database and domain names database.

11. The method of claim 1 wherein said trademark is chosen from a group consisting of trademarks, trade dress, trade names, service marks, collective membership marks, collective trademark/service marks and certification marks.

12. The method of claim 1, further comprising the act of populating the graph with a data point comprising a mark from a trademark watch report.

13. The method of claim 1, further comprising generating a third axis having one or more countries, whereby each country has an associated graph, and whereby each data point is plotted on a graph using the mark description, the goods/services description and country associated with the at least one mark.

14. The method of claim 13, wherein a row or column of the graph may be selected thereby displaying a selected mark description or a selected goods/services description for all countries on the third axis.

15. The method of claim 1, further comprising:
outputting the graph to a computer memory location via a computer network; and
retrieving the graph from the computer memory location using a computer coupled to the computer network.

16. The method of claim 1, further comprising the act of receiving the trademark search from a trademark search entity.

17. The method of claim 1, further comprising the act of performing the trademark search.

18. A method for presenting information associated with a trademark search for a trademark, the method comprising:
identifying a mark description and a goods/services description associated with the trademark;
generating a graph having a first axis and a second axis, wherein the origin of the graph comprises the intersection of the first and second axis, the first axis having one or more descriptions of goods/services and the second axis having one or more mark descriptions, wherein the origin comprises the goods/services description and the mark description associated with the trademark;
populating the graph with at least one data point, the act of populating comprising:
locating a mark description and a goods/services description associated with a mark from the trademark search on the first and second axis;
plotting a data point on the graph using the goods/services description and the mark description associated with the mark from the trademark search;
receiving a trademark watch report;
populating the graph with at least one data point comprising:
locating a mark description and a goods description associated with a mark from the trademark watch report on the first and second axis; and
plotting a data point on the graph using the goods description and the mark description associated with the mark from the trademark watch report.

19. The method of claim 18 further comprising:
selecting the mark description and the goods description associated with the mark from the trademark watch report; and
placing the goods description associated with the mark from the trademark watch report on the first axis and the mark description associated with the mark from the trademark watch report on the second axis.

20. The method of claim 18 further comprising the act of sending a message notifying a user that a data point has been added to the graph.

21. A method for presenting information associated with a trademark search for a trademark, the method comprising:
generating a graph having a first axis and a second axis, wherein the origin of the graph comprises the intersection of the first and second axis;
creating a plurality of goods and services descriptions using the goods description associated with the trademark;
placing the goods description associated with the trademark at a point on the first axis of the graph closest the origin of the graph and thereafter placing the plurality of goods descriptions at points on the first axis of the graph;
creating a plurality of mark descriptions using the mark description associated with the trademark;
placing the mark description associated with the trademark at a point on the second axis of the graph closest the origin of the graph and thereafter placing the plurality of mark descriptions at points on the second axis of the graph; and
populating the graph with at least one data point comprising a mark from the trademark search by plotting the data point using the description and the mark description associated with a mark from the trademark search.

22. The method of claim 21, wherein the act of creating a plurality of goods descriptions further comprises:
identifying goods and services descriptions being offered by the trademark owner;
identifying goods and services descriptions intended to be offered by the trademark owner; and
identifying goods and services descriptions from the trademark search.

23. The method of claim 21, wherein the act of placing the plurality of goods descriptions at points on the first axis of the graph further comprises prioritizing the plurality of goods descriptions in order of decreasing similarity to the goods description associated with the trademark, wherein the similar marks are closer the origin.

24. The method of claim 21, wherein the act of creating a plurality of mark descriptions further comprises:
identifying mark descriptions having an identical mark description;
identifying mark descriptions having a closely similar mark description;
identifying mark descriptions having a phonetically similar mark description; and
identifying mark description having one or more words or letters used in the mark description associated with the trademark.

25. The method of claim 21, wherein the act of placing the plurality of mark descriptions at points on the second axis of the graph further comprises prioritizing the plurality of mark descriptions in order of decreasing similarity to the mark description associated with the trademark, wherein the similar marks are closer the origin.

26. A computer implemented graphical user interface for capturing and displaying information associated with a trademark search for a trademark, the interface comprising:
a diagram having a first axis and a second axis, wherein the origin of the diagram comprises the intersection of the first and second axis, the first axis having one or more goods descriptions and the second axis having one or more mark descriptions, wherein the origin comprises the goods description and the mark description associated with the trademark; and
a user selectable data point comprising a mark from the trademark search plotted on the graph using the goods description and mark description for the mark, the user selectable data point configured to invoke a retrieve and display tool to retrieve information associated with the user selectable data point and thereafter display the information on a computer display.

27. The graphical user interface of claim 26, wherein the graphical user interface is resident on a server accessible by a computer network.

28. The graphical user interface of claim 27, wherein the server is a component of a computer network associated with a trademark search entity.

29. The user interface of claim 26, wherein the one or more goods descriptions are chosen based upon criteria associated with the description of goods associated with the trademark.

30. The user interface of claim 26, wherein the one or more mark descriptions are chosen based upon criteria associated with the mark description associated with the trademark.

31. The user interface of claim 26, wherein the information associated with the user selectable data point comprises the mark description, the owner of the mark, the description of goods associated with the mark, the first use of the mark and the current status of the mark.

32. A computer program that facilitates the presentation of trademark information associated with a trademark search, comprising, on a computer readable medium:
a first component that performs an act of requesting the trademark search for the trademark;
a second component that performs an act of generating a graph having a first axis and a second axis, the first axis having one or more descriptions of goods and the second axis having one or more mark descriptions, wherein the origin on the first and second axes of the graph comprises the goods description and the mark description associated with the trademark;
a third component that performs an act of populating the graph with a plurality of data points comprising one or more marks from the trademark search, wherein each data point represents at least one mark from the trademark search whereby each data point is plotted on the graph using the goods description and the mark description associated with the at least one mark.

33. The computer program of claim 32, further comprising a fourth component that outputs the graph to a memory location accessible by a computer network.

34. The computer program of claim 32, further comprising a fourth component that performs an act of displaying the graph on a computer.

35. A graphical method for presenting information associated with a trademark search, the method comprising the computer implemented steps of:
generating a graph having a first axis and a second axis, wherein the origin of the graph comprises the intersection of the first and second axis, the first axis having one or more descriptions of goods and the second axis having one or more mark descriptions, wherein the origin comprises the goods description and the mark description associated with the trademark;
populating the graph with a plurality of data points comprising one or more marks from the trademark search, wherein each data point represents at least one mark from the trademark search whereby each data point is plotted on the graph using the goods description and the mark description associated with the at least one mark; and
storing the graph in a memory location accessible by a computer network.

36. A computer implemented method for presenting information associated with a trademark search for a trademark, the method comprising:
performing the trademark search for the trademark, wherein the trademark has an associated goods description and mark description;
generating an interactive graph having a first axis and a second axis, wherein the origin of the graph comprises the intersection of the first and second axis;
placing the goods description associated with the trademark at a point on the first axis of the graph closest the origin of the graph and thereafter placing a plurality of goods descriptions at points along the first axis of the graph;
placing the mark description associated with the trademark at a point on the second axis of the graph closest the origin of the graph and thereafter placing a plurality of mark descriptions at points along the second axis of the graph;
populating the graph with at least one user selectable data point comprising a mark from the trademark search, the act of populating comprising:
locating the mark description and the goods description associated with the mark from the trademark search on the first and second axis; and
plotting the user selectable data point using the goods description and the mark description associated with the mark from the trademark search; and
outputting the graph to a memory location accessible by a computer network.

37. The computer implemented method of claim 36, further comprising displaying information associated with the user selectable data point in response to selecting the user selectable data point.

38. The computer implemented method of claim 37, wherein selecting further comprises placing a computer generated pointer over the user selectable data point.

39. The computer implemented method of claim 36, wherein the information associated with user selectable data point comprises the mark description, goods/services description and status of the mark from the trademark search.

40. The computer implemented method of claim 36, further comprising notifying a user of the memory location having the graph.

41. The computer implemented method of claim 36, further comprising:
selecting a number less than all of the plurality of mark descriptions from the second axis;
selecting a number less than all of the plurality of goods descriptions from the first axis;
generating a second interactive graph having a first axis and a second axis, wherein the origin of the graph comprises the intersection of the first and second axis;
placing the goods description associated with the trademark at a point on the first axis of the graph closest the origin of the graph and thereafter placing the les than all of the plurality of goods descriptions at points along the first axis of the graph; and
placing the mark description associated with the trademark at a point on the second axis of the graph closest the origin of the graph and thereafter placing the less than all of the plurality of mark descriptions at points along the second axis of the graph;
populating the second interactive graph with at least one user selectable data point comprising a mark from the trademark search, the act of populating comprising:
locating the mark description and the goods description associated with the mark from the trademark search on the first and second axis; and
plotting the user selectable data point using the goods description and the mark description associated with the mark from the trademark search; and
outputting the second interactive graph to a memory location accessible by a computer network.

42. A system for presenting trademark information associated with a trademark search for a trademark, the system comprising:
a database accessible over a computer network, the database operable to:
store a graph in a memory location accessible to the computer network; and
communicate the stored graph over the computer network;
a server operable to communicate with the database over a computer network, the server operable to:
generate a graph having a first axis and a second axis, wherein the origin of the graph comprises the intersection of the first and second axis, the first axis having one or more descriptions of goods and the second axis having one or more mark descriptions, wherein the origin comprises the goods description and the mark description associated with the trademark;
populate the graph with at least one data point comprising:
locating a mark description and a goods description associated with a mark from the trademark search on the first and second axis; and
plotting a data point on the graph using the goods description and the mark description associated with a mark from the trademark search.

43. A method for presenting information associated with a trademark, the method comprising:
identifying a mark description and a first international class of goods/services associated with the trademark;
generating a graph having a first axis and a second axis, wherein the origin of the graph comprises the intersection of the first and second axis, the first axis having one or more international classes of goods/services and the second axis having one or more mark descriptions, wherein the origin comprises the first international class of goods/services and the mark description associated with the trademark;
populating the graph with at least one data point, the act of populating comprising:
locating a mark description and an international class of goods/services associated with a mark from the trademark search on the first and second axis; and
plotting a data point on the graph using the international class of goods/services and the mark description associated with the mark from the trademark search.

44. The method of claim 43 wherein the one or more international classes of goods/services are defined in the International Schedule of Classes of Goods and Services, as defined by the international treaty and the U.S. trademark rules and regulations.
